(19) United States
(12) Patent Application Publication
(10) Pub. No.: US 2017/0171649 A1
(43) Pub. Date: Jun. 15, 2017

(54) Active Loudspeaker Column System

(71) Applicant: Adam Hall GmbH, Neu-Anspach (DE)

(72) Inventor: Alexander Pietschmann, Usingen (DE)

(73) Assignee: Adam Hall GmbH

(21) Appl. No.: 15/356,901

(22) Filed: Nov. 21, 2016

(30) Foreign Application Priority Data
Dec. 10, 2015 (DE) 102015224848.8
Jun. 3, 2016 (DE) 102016209786.5

(51) Int. Cl. H04R 1/02; H02J 7/00; H04R 3/14

(52) U.S. Cl. CPC H04R 1/025; H04R 3/14; H02J 7/0042; H02J 7/0047; H04R 2201/028

(57) ABSTRACT

A column loudspeaker system is provided. The column loudspeaker system includes a subwoofer base and a loudspeaker column arrangement. The loudspeaker column arrangement includes a loudspeaker region with at least one loudspeaker and an extension region disposed between the subwoofer base and the loudspeaker region and is electrically and mechanically connected thereto. The at least one rechargeable battery is provided in the loudspeaker column or subwoofer base.

### CROSS-REFERENCE TO RELATED APPLICATION

This application claims under 35 U.S.C. §119(a) the benefit of priority to German Patent Application No. 102015224848.8 filed on Dec. 10, 2015, and to German Patent Application No. 102016209786.5 filed on Jun. 3, 2016. The applications are incorporated herein by reference.

### BACKGROUND

1. Field of Disclosure

The present disclosure relates to an active column loudspeaker system.

2. Description of the Related Art

Generally, a column loudspeaker system includes a subwoofer base and a loudspeaker column that has at least one loudspeaker. An arrangement is disposed between the subwoofer base and the loudspeaker column having at least one extension column which is electrically and mechanically connected to the subwoofer base and the loudspeaker column. Typically, in this arrangement, power is supplied via a cable which is inserted into a power source (e.g. a wall socket).

The above information disclosed in this section is intended merely to aid in the understanding of the background of the invention, and therefore may contain information that does not form the prior art that is already known to a person of ordinary skill in the art.

### SUMMARY

The active loudspeaker column system provides a loudspeaker column arrangement that includes a one-piece component, a loudspeaker region with at least one loudspeaker and an extension region disposed between the subwoofer base and the loudspeaker region. Accordingly, the loudspeaker region may form the uppermost component of the column loudspeaker system when in the operating state. In other words, the loudspeaker region and the extension region in this case form a single column. Further, either a rechargeable battery may be provided in this loudspeaker column arrangement or such a rechargeable battery may be provided in the subwoofer base or a rechargeable battery may be provided both in the loudspeaker column arrangement and also in the subwoofer base. The battery may form an integrated power source and may be electrically connected to the components of the column loudspeaker system which are to be supplied with power.

In another exemplary embodiment in addition to the subwoofer base, the active column loudspeaker system may have a separate component that is loudspeaker column and may include at least one loudspeaker or a plurality of loudspeakers. In an exemplary embodiment, the extension region may be as a separate component in the form of an extension column or a plurality of extension columns. In an exemplary embodiment, the loudspeaker column and one or a plurality of extension columns may be connected to one another. At a substantially simultaneous time the mechanical and electrical connection may be adjusted. For example, in this exemplary embodiment the loudspeaker column with the loudspeakers thereof constitutes the uppermost component that may be disposed a greater distance away from the subwoofer base. In some exemplary embodiments, a battery may be provided in the subwoofer base or in the single extension column, or, in the case of a plurality of extension columns, in an extension columns, whereby a column loudspeaker system may be formed independent of an external power sources.

In particular, a rechargeable battery or an arrangement of a plurality of rechargeable batteries, (e.g. in one of the extension columns or a plurality of extension columns when a plurality of these extension columns are provided) based on the expected power requirement. When a plurality of extension columns, generally two such extension columns are provided, the battery may be disposed in the extension column which is directly connected to the subwoofer base. Furthermore, the subwoofer base may include an integrated charging station so that separate charging station is required to recharge a discharged battery. In other words, the subwoofer base may be connected to an external power source and may be configured to perform the battery recharging process via the integrated charging station.

Alternatively, a charging station as a distinct component, may be separated from the subwoofer base, as a system component when the extension column is attached to the battery for the charging process. A separate charging station may be a specific charging device (e.g. for the extension column provided with a battery), or a commercially available charging device for a battery, (e.g. a normal barrel power connector), with the aid of which the battery or accumulator may be recharged. In a particularly an exemplary embodiment may include a display device (e.g. on one of the extension columns and displays the charge state of the battery).

In particular, this display device may be designed as a bar display, that includes flashing bars during the charging process, and may be configured to display the charge state during operation, wherein in the fully charged state, all bars are displayed e.g. in colour and during operation the bars gradually lose their colouring based on the charge state. In order to be able to warn the operator of the column loudspeaker system in accordance with the invention of imminent complete discharge, a warning device may be configured to emit an acoustic or visual signal (e.g. about five or ten minutes) prior to final discharge of the battery.

Furthermore, a system component may include an additional extension column which includes a rechargeable battery and may be a replacement component for the extension column, disposed within the column loudspeaker system during operation. In an exemplary manner, the electromechanical connection device between the extension columns, the loudspeaker column and the subwoofer base may be designed as an easily handled plug connection which, when the components of the column loudspeaker system are fitted together, may form both the mechanical and also the electrical connection.

The exemplary embodiments may be an active column loudspeaker system in accordance with an exemplary embodiment that may include a subwoofer base and a loudspeaker column arrangement. In this exemplary embodiment, the loudspeaker column arrangement also comprises at least one loudspeaker region with at least one loudspeaker and at least one extension column which is disposed between the subwoofer base and the loudspeaker region and may be electrically and mechanically connected thereto.

This exemplary embodiment of the column loudspeaker system (e.g., a loudspeaker column system) may include an adapter that may be configured to separate the entire loudspeaker column arrangement or a portion of the loudspeaker region of the loudspeaker column arrangement from the subwoofer and to accommodate the subwoofer, when necessary or desired, at a different set-up position than the loudspeaker column arrangement or to accommodate the loudspeaker region. For example, when the set-up area is restricted, the subwoofer base may be disposed separate from the loudspeaker column arrangement, or when desirable for visual reasons or relating to technical operation. In particular, the loudspeaker column arrangement may be separated from the subwoofer base and fixed in the adapter via an mechanical-electrical plug connection, the adapter may be connected via a signal line to the subwoofer base, which is separated from the loudspeaker column arrangement, or even to another external separate signal source. The loudspeaker column arrangement and the loudspeaker region may be placed on a stand or may be coupled to a wall via a wall bracket.

When the loudspeaker column arrangement is then to be connected directly to the subwoofer base, the adapter may be separated from the loudspeaker column arrangement or the loudspeaker region and then directly connected to the subwoofer base or the loudspeaker region may then be connected to the extension region. This column loudspeaker system, like the exemplary embodiment explained with the aid of FIGS. 1 to 10, may be provided with a rechargeable battery, or the column loudspeaker system may be connected via a corresponding connection cable to an external power source, e.g. the socket in a building.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 shows an exemplary schematically slightly simplified view of a front view of a column loudspeaker system in accordance with an exemplary embodiment of the disclosure;

FIG. 2 shows an exemplary perspective view of the loudspeaker column system of FIG. 1 in accordance with an exemplary embodiment of the disclosure;

FIGS. 3-7 show exemplary side views of the column loudspeaker system in accordance with an exemplary embodiment of the disclosure during a charging process and when the integrated battery is in different charging states;

FIG. 8 shows an exemplary perspective view of an extension column in accordance with an exemplary embodiment of the disclosure;

FIG. 9 shows an exemplary schematically slightly simplified view of a side view of an external charging station with an extension column placed thereon in accordance with an exemplary embodiment of the disclosure;

FIG. 10 shows an exemplary rear view of a lower region of the column loudspeaker system 1 in accordance with an exemplary embodiment of the disclosure; and

FIG. 11 shows an exemplary exploded view, corresponding to FIG. 1, of a further embodiment of a column loudspeaker system in accordance with an exemplary embodiment of the disclosure.

### DETAILED DESCRIPTION

Hereinafter, a power module according to one exemplary embodiment of the present disclosure and a method of manufacturing the same will be described with reference to the accompanying drawings to allow those skilled in the art to easily practice the present disclosure. Advantages and features of the present disclosure and methods for achieving the same will be clearly understood with reference to the following detailed description of exemplary embodiments in conjunction with the accompanying drawings. However, the present disclosure is not limited to the exemplary embodiments disclosed herein, but may be implemented in various different forms. The exemplary embodiments are merely given to make the disclosure of the present disclosure complete and to completely instruct the scope of the disclosure to those skilled in the art, and the present disclosure should be defined by the scope of the claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present disclosure clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

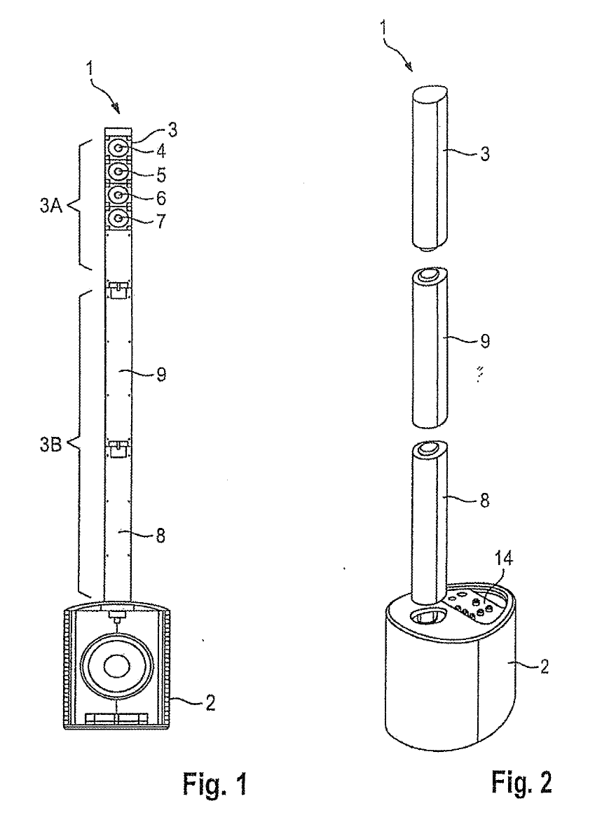

As shown by a combined view of FIGS. 1 and 2, in this exemplary embodiment an active column loudspeaker system (column loudspeaker device 1) may include a subwoofer base 2. Furthermore, the column loudspeaker system 1 may include a loudspeaker column 3 that may be provided in the example with four loudspeakers 4-7 and may form the uppermost, and therefore highest disposed, component of the column loudspeaker system 1. As explained in the introduction, the column loudspeaker system 1 in accordance with the disclosure to comprise a unitary column, which is symbolised in FIG. 1 by the reference signs “3A” and “3B”, which in this case would constitute a single component, wherein the region 3A may be the loudspeaker region and the region 3B may be the extension region. However, reference is made herein throughout to the embodiment illustrated in FIGS. 1 to 10, having a loudspeaker column 3 and two extension columns 8 and 9, which is merely given by way of example.

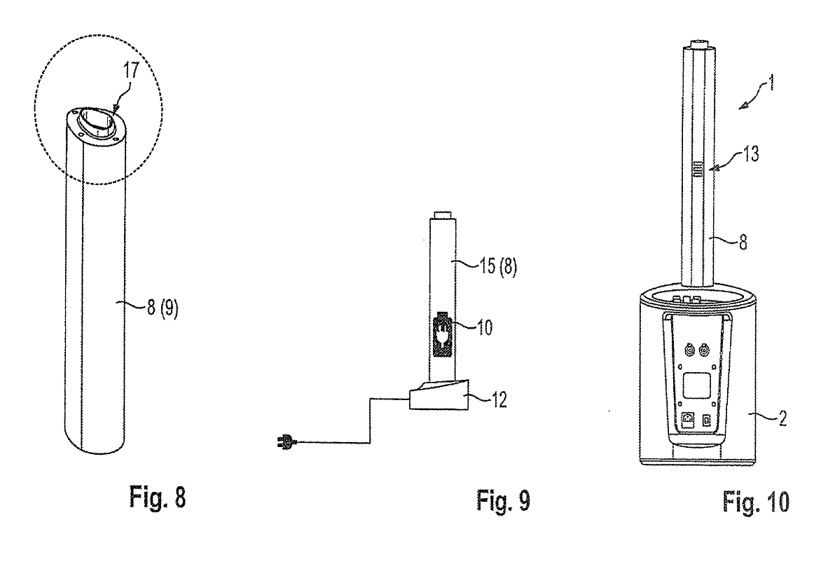

In the illustrated example of FIGS. 1 and 2, an arrangement of two extension columns 8 and 9 may be disposed between the subwoofer base 2 and the loudspeaker column 3. The extension columns 8 and 9 are identical and may be connected both mechanically and also electrically to the subwoofer base 2, to one another and to the loudspeaker column 3. For this purpose, a plug system 17 shown in FIG. 8 may be provided which effects the electrical and mechanical connection of the components. In the exemplary embodiment illustrated in FIGS. 1 and 2, the subwoofer base may include an integrated mixing desk 14, which, however, does not constitute an obligatory component but rather an optional embodiment.

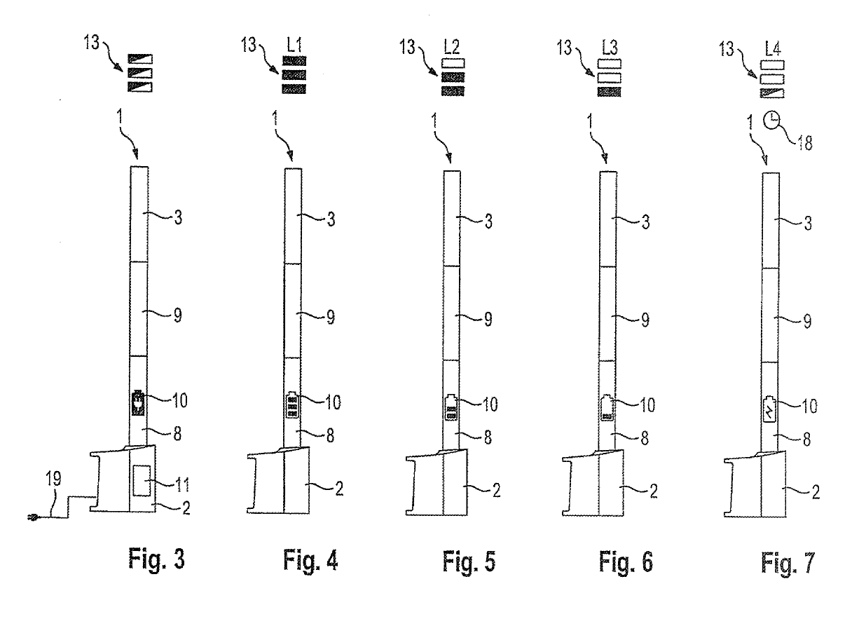

FIGS. 3 to 7 show that the column loudspeaker system 1 in accordance with the disclosure is provided with at least one rechargeable battery (accumulator) 10. In the example, this battery 10 may be disposed in the extension column 8 connected directly to the subwoofer base. However, in principle, it would also be possible to provide the battery 10 in another extension column such as e.g. extension column 9. Furthermore, it is also feasible for not just one but a plurality of such batteries 10 to be provided.

FIG. 3 shows an integrated charging station in the subwoofer base 2 may be provided this charging station being illustrated in FIG. 3 in a schematically greatly simplified manner as a block 11. FIG. 3 shows the state in which the battery 10 may be recharged by the integrated charging device 11, wherein the subwoofer base 2 or the integrated charging station 11 may be connected via a connection cable 19 to an external power source, not shown in FIG. 3. Thus in FIG. 3, the battery 10 may be symbolically provided with the plug of the cable 19 for the charging process.

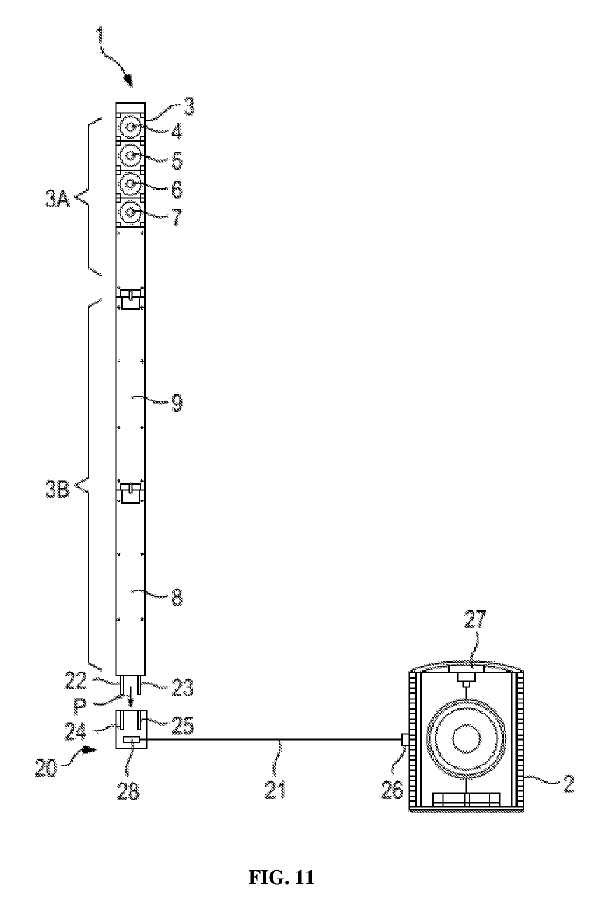

During the charging process, an optionally provided display device 13, which, in accordance with FIG. 10, may be disposed (e.g. on the extension column 8), may flash. Further the display device 13 illustrated in FIGS. 3 to 7 and 10 may be a bar display with three bars. For example, other exemplary embodiments of the display device 13 are also feasible. During the charging process, the bars of the display device 13 flash. When the charging process is complete, the charge state L1 may be shown by all the bars of the display device 13 being displayed in this case in black. The sequence of FIGS. 4 to 7 may show the drop in the charge state of the battery 10, according to which the display device 13 loses its black bars one after another until reaching the state shown in FIG. 7 in which the lowermost bar is still partially displayed in colour. Below the display device 13 a warning device 18 may be symbolically illustrated as a circle, this being able to emit a visual or acoustic warning signal, preferably prior to final discharge, wherein this period of time can be e.g. five or ten minutes.

FIG. 9 illustrates an alternative exemplary embodiment in which, instead of an integrated charging station 11, an external charging station 12 may be provided onto which an extension column with the battery 10 can be placed in order to recharge it. In FIG. 9, the extension column may be designated with the reference sign 15(8) since it is possible, in addition to the extension column 8 with the battery 10, as shown in FIGS. 3 to 7, to provide a further extension column 15 as a replacement part which is likewise provided with a battery 16 so that a fully charged battery may be provided in a replacement extension column. Therefore, in the event of the discharge e.g. of the extension column 8, this extension column may be replaced by the extension column 15 having a fully charged battery 16 in order to be able to continue to operate the column loudspeaker system 1, and to place the extension column 8 with a discharged battery 10 onto the external charging system 12.

According to FIG. 11, a further exemplary embodiment of an active column loudspeaker system 1 is illustrated. With respect to features 2 to 4, 3, 3A and 5 to 9, reference may be made to the description above. These features are all also provided in the case of the column loudspeaker system 1 in accordance with FIG. 11.

The illustration of FIG. 11 shows a state in which the loudspeaker column arrangement 3A, 3B may be been separated from the subwoofer base 2. This is indicated by the socket pins 22 and 23 which have been removed (e.g., pulled out) from the connection socket 27 of the subwoofer base 2, whereby the loudspeaker column arrangement 3A, 3B may be separated from the subwoofer base 2. A separation may be as explained above, desirable when, for reasons of space or visual reasons, the subwoofer base 2 is e.g. not to be disposed in the field of view of the loudspeaker column arrangement 3A, 3B. For this purpose, the exemplary embodiment of the column loudspeaker system 1 in accordance with FIG. 11 may include an adapter 20 which has connection sockets 24 and 25 into which the socket pins 22 and 23 can be inserted. In this state, the loudspeaker column arrangement 3A, 3B may be disposed separately from the subwoofer base 2 at a set-up position, and may be connected via a signal line 21 to the subwoofer base 2 or to another separate signal source.

For this purpose, the adapter 20 may include a signal input 28 and the subwoofer base 2 may include a signal output 26, which can be connected to one another via the signal line 21. The socket pins may form a mechanical connection, for which purpose two pins will suffice but three or four such pins may also be provided. The electrical connection may be made via an electrical plug connection, not shown in the drawing. Accordingly during placement of the loudspeaker column arrangement 3A, 3B or of the loudspeaker region 3A onto the adapter 20 or the subwoofer 2 both a mechanical and also an electrical connection may be produced. As an alternative to this arrangement, it is also possible merely to connect the loudspeaker region 3A to the adapter 20 since the loudspeaker region 3A may be separated from the extension region 3B and, by reason of the same electromechanical connection construction, may likewise be connected to the adapter 20, should it not be necessary to set up the extension region 3B together with the loudspeaker region 3A.

In addition to the written disclosure of the disclosure given above, reference is hereby explicitly made to the illustration thereof in the drawings of FIGS. 1 to 11.

While this disclosure has been described in connection with what is presently considered to be exemplary embodiments on the contrary, it is intended to cover various modifications and equivalent arrangements, without departing from the scope and spirit of the disclosure as disclosed in the accompanying claims. In addition, it is to be considered that all of these modifications and alterations fall within the scope of the present disclosure.

### LIST OF REFERENCE SIGNS

1 active column loudspeaker system (column loudspeaker device)

2 subwoofer base

3 loudspeaker column

3A, 3B loudspeaker column arrangement

4-7 loudspeakers

8, 9 extension columns

10 rechargeable battery (accumulator)

11 charging station (integrated in the subwoofer 2)

12 external charging station

13 display device

14 mixing desk

15 additional extension column

16 battery of the additional extension column

17 plug connection

18 warning device

19 electrical connection cable

20 adapter

21 signal line

22, 23 socket pins

24, 25 connection sockets

26 signal output

27 plug socket

28 signal input

L1-L4 charge states

1. An active column loudspeaker system, comprising:
a subwoofer base;
a loudspeaker column arrangement that includes a loudspeaker region with at least one loudspeaker; and
an extension region disposed between the subwoofer base and the loudspeaker region and is electrically and mechanically connected thereto,
wherein at least one rechargeable battery is provided in the loudspeaker column or subwoofer base.

2. The system of claim 1, wherein the loudspeaker region is designed as a loudspeaker column having a separate component and
wherein the extension region includes one or a plurality of extension columns forming separate components,
wherein the loudspeaker column and the extension column is electrically and mechanically connected to one another, and that the battery is disposed in the extension column adjoining the subwoofer base.

3. The system of claim 1 further comprising a charging station integrated into the subwoofer base

4. The system of claim 1 wherein the extension column included with the battery is connected to an external charging station.

5. The system of claim 1, further comprising a display device configured to display the charge state (L1-L4) of the battery that is disposed on the extension column.

6. The system of claim 5, wherein the display device is designed as a bar display.

7. The system of claim 1, further comprising a warning device configured to emit an acoustic or visual warning signal at a predetermined time prior to complete battery discharge.

8. The system of claim 1 wherein the subwoofer base includes an integrated mixing desk.

9. The system of claim 1 wherein, at least one additional extension column having a rechargeable battery is provided as a replacement part.

10. The system of claim 1, further comprising a plug connection provided as an electromechanical connection device.

11. An active column loudspeaker system, comprising:
a subwoofer base;
a loudspeaker column arrangement; having a loudspeaker region with a loudspeaker, and an extension region disposed between the subwoofer base and the loudspeaker region and is electrically and mechanically connected thereto,
wherein an adapter is electrically and mechanically connected to the loudspeaker column arrangement or to the loudspeaker region, and via the loudspeaker column arrangement or wherein the loudspeaker region is connected to the subwoofer base or another external separate signal source using a signal line

12. The system of claim 11, characterised by at least one characterising part of claim 2.
